(19) United States
(12) Patent Application Publication
(10) Pub. No.: US 2021/0252592 A1
(43) Pub. Date: Aug. 19, 2021

(54) MICRO AND NANO-SIZED ANISOTROPIC PARTICLE FABRICATION TECHNIQUE

(71) Applicant: ORTA DOGU TEKNIK UNIVERSITESI, Ankara (TR)

(72) Inventor: Simge CINAR, Ankara (TR)

(73) Assignee: ORTA DOGU TEKNIK UNIVERSITESI, Ankara (TR)

(21) Appl. No.: 17/268,965

(22) PCT Filed: Aug. 29, 2019
(86) PCT No.: PCT/TR2019/050716

§ 371 Date: Feb. 17, 2021

(30) Foreign Application Priority Data
Sep. 1, 2018 (TR) 2018/12474

(51) Int. Cl. B22F 1/00; B22F 1/02

(52) U.S. Cl. CPC B22F 1/0062; B22F 2301/30; B22F 1/02; B22F 1/0018

(57) ABSTRACT

A method of producing nano and micro sized particles having an anisotropic composition and/or morphology is provided. A composition distribution is on a surface or throughout a particle. The nano and micro sized particles are metal, inorganic, or combinations thereof; and the nano and micro sized particles are known as hard anisotropic particles.

### CROSS REFERENCE TO THE RELATED APPLICATIONS

This application is the national stage entry of International Application No. PCT/TR2019/050716, filed on Aug. 29, 2019, which is based upon and claims priority to Turkish Patent Application No. 2018/12474, filed on Sep. 1, 2018, the entire contents of which are incorporated herein by reference.

### TECHNICAL FIELD

The invention is related to a method of producing micro and nanometer sized particles having anisotropic composition and/or morphology. This composition distribution can be on the surface (core-shell structure) or it can be distributed throughout the particle (coreless structure). The fabricated particles can be metal, inorganic or combinations thereof, and these types of particles are known as hard anisotropic particles.

### BACKGROUND

Nanoparticles are used in the majority of nanotechnology products. These particles have a single chemical component (element, compound, alloy etc.) and this component has been distributed homogenously inside the particle. It has superior properties due to its nanosize, however these properties focus on a single function. Anisotropic particles, on the other hand, (i) combine multiple components in a single particle; therefore, they can be more efficient, and multifunctional; (ii) can create synergic effects as a result of combination of different components; and (iii) can be used in various new applications that are not available before.

The studies on the anisotropic particles, particularly on the hard anisotropic particles (anisotropic particles made of metals, inorganic materials or their combination), belong to the last 10-15 years; however, there are only a limited number of scalable fabrication technique in this field. Although several application areas have been suggested and the proof of concept studies have been reported for such particles, a known industrial application has not been yet available. A fabrication technique for anisotropic particles based on the effect of solidification processes of metallic alloys and the applied surface forces is not disclosed in the prior art. The other present methods include variations of partial masking of particles followed by their selective engineering or functionalization. Moreover, the fabricated particles using the present scalable techniques exhibit anisotropy only at their surfaces.

Anisotropic particle fabrication techniques present in literature can be divided into two fundamental groups: (1) anisotropic particle fabrication techniques by bottom-up synthesis techniques based on thermodynamics and chemistry; they have low yield, generally require very special fabrication conditions and expensive reagents, and are environmentally unfriendly. They have been customized for certain material pairs and they are not scalable. (2) Other scalable methods rely on partial masking of particles followed by coating with selective engineering and functionalization techniques. Particles fabricated using such techniques are not durable. Moreover, the particles need to meet certain pre-requisites for these methods to be applied. Therefore, they are not versatile. For this reason, alternative methods are required for fabrication of anisotropic particles.

### SUMMARY

The method subject to the invention mainly uses isotropic particles that have been produced from metal alloys as a starting material. The invention is related to the fabrication of anisotropic particles via control or manipulation of the distribution of phases in a particle by means of solidification of melting or heat-treatment of such particles and/or by the application of external forces on their surfaces. The starting alloy particles can be solid or supercooled particles that have been produced with any method. This sets forth that, anisotropic particles can be fabricated by changing the composition distribution and morphology thereof by melting and controlled solidification of solid particles, or by heat-treatment and controlled solidification of supercooled particles, or by heat treatment of particles, or by application of forces on particle surfaces at room temperature or at other temperatures. Moreover, morphological anisotropy can be obtained during phase transformations because of the different volume expansion coefficient of components constituting the particle.

The method of the invention is a scalable, cost-effective method that can easily be applied to various combinations of metal or inorganic content and can be adopted to the fabrication of hybrid particles by the addition of simple steps.

Contrary to the currently available techniques, the anisotropic particle fabrication method by control and manipulation of solidification processes subject to the invention is suitable for large-scale production. The method allows use of a substantially wide spectrum in terms of particle size dispersion and material types. It does not require controlled environments or qualified personnel for application. As a result, it is suitable for cost-effective particle production with high yields in a relatively short period of time. Therefore, the method has a potential to overcome the problems in fabrication of metallic anisotropic particles for its widespread use in industry.

Furthermore, the method of the present invention is not only suitable for fabrication of particles with surface anisotropy, but also with anisotropy from the core to the surface (FIG. 3).

The technique provided with this invention is related to changing the surface chemistries and the morphologies of the particles by subjecting the fabricated particles to external factors that can be applied simultaneously and easily to large volumes such as, heat treatments at various temperatures, to electrical fields, magnetic fields, pressure and shear force. Therefore, this technique is cost-effective and fast. After an effective process parameter(s) is/are determined for different material pairs (or for triple or even more complex systems), it does not require significant changes in the production process.

It is suitable for the production of particles with different sizes, because aforementioned external effects can be easily applied to particles at different size range in a similar way. Additionally after the process is determined, it does not require the use of cutting-edge devices or qualified personnel.

The technique set forth with the invention is applied to a bismuth-tin alloy system, and to particles having different sizes; and various morphological and chemical anisotropy is successfully obtained.

The present invention is related to the fabrication of anisotropic particles. The fabricated particles can later be used in many sectors including electronics, biotechnology, chemistry, microrobots, environmental remediation and coating.

### BRIEF DESCRIPTION OF THE DRAWINGS

FIG. 1: Schematic for fabrication procedure of anisotropic particles

FIGS. 2A, 2B and 2C: Anisotropic particles can be obtained using hypo-eutectic and hyper-eutectic composition alloys. Here hypo-eutectic composition is exemplified. In resulting particles, bismuth-rich patches or sides are decorated the eutectic particles. Two-faced, Janus, structures are formed in FIGS. 2A, 2B and 2C.

FIGS. 2D and 2E: Anisotropic particles can be obtained using hypo-eutectic and hyper-eutectic composition alloys. Here hypo-eutectic composition is exemplified. In resulting particles, bismuth-rich patches or sides are decorated the eutectic particles. Various patchy structures are exemplified.

FIG. 2F: Anisotropic particles can be obtained using hypo-eutectic and hyper-eutectic composition alloys. Here hypo-eutectic composition is exemplified. In resulting particles, bismuth-rich patches or sides are decorated the eutectic particles. Two-faced Janus structures are formed and particles with both chemical and shape anisotropy can be observed.

FIGS. 3A and 3B: The fabricated Janus particles are coreless structures. When the Janus particle presented in FIG. 3A, is sliced using a focused ion beam, it is observed that anisotropy was present not only on the surface but throughout the particle.

FIGS. 4A and 4B: The surface microstructure of the particles may vary according to particle size. While in FIG. 4A the typical complex eutectic microstructure of the eutectic bismuth tin alloy is observed, this microstructure becomes coarse in smaller particles as presented in FIG. 4B.

FIG. 5A: The effects of rapid solidification and isothermal heat treatment. Supercooled particles are solidified by cooling down to −20° C., the degree of supercooling is measured as 150° C. Particles are evolved to structures with stripes.

FIG. 5B: Supercooled particles are exposed to a heat treatment at 120° C. for 8 hours, the structures are coarsened and formed particles with fewer stripes or patches.

FIG. 6A: The effect of cyclic heat treatment on the particle microstructure. The particles with the degree of supercooling of 150° C. are used.

FIG. 6B: The particles are first cooled to −80° C. and solidified, then, they are heated up to 300° C. and are cooled back to −80° C. Following the first melting solidification cycle, the striped particles are obtained.

FIGS. 6C and 6D: The particles are first cooled to −80° C. and solidified, then, they are heated up to 300° C. and are cooled back to −80° C. and the melting solidification cycle is repeated once more. When the heat treatment cycle is applied twice, two faced Janus structure are obtained.

FIGS. 7A, 7B, 7C and 7D: The effects of high speed stirring and cooling rate. After the molten particles are stirred at high speed (>10,000 rpm), they are slowly cooled to room temperature. While the small particles (<1-2 μm) remained supercooled and/or at an isotropic state, the larger particles (≥1 μm) are solidified and anisotropic structures are obtained. The fabricated anisotropic particles are composed of bismuth-rich and tin-rich sides. As the change in volume of bismuth and tin during solidification are different, not only chemical but also morphological varieties of anisotropic structures are obtained. The shapes that can be obtained depend on particle size as shown in FIG. 7D.

FIG. 8A: The effect of shear force on the particle structure. The particles are produced according to the procedure mentioned in FIG. 7; however, stainless steel anchor blades are used as a stirrer. The surfaces of the fabricated particles are bismuth-rich. While there were regions that is enriched by bismuth.

FIG. 8B: The effect of shear force on the particle structure. The particles are produced according to the procedure mentioned in FIG. 7; however, stainless steel anchor blades are used as a stirrer. The surfaces of the fabricated particles are bismuth-rich. The stripe microstructure is thickened and the surface is enriched by bismuth.

FIG. 8C: The effect of shear force on the particle structure. The particles are produced according to the procedure mentioned in FIG. 7; however, stainless steel anchor blades are used as a stirrer. The surfaces of the fabricated particles are bismuth-rich. The eutectic side of the Janus particle is enriched by bismuth in a similar way the one observed in FIG. 8B.

### DEFINITIONS OF THE PARTS/ASPECTS/SECTIONS FORMING THE INVENTION

### A: Shell

### B: Alloy

1: Supercooled or molten alloy particle enveloped by a shell.
2: Solid alloy particle
3: Application of various external forces on the surfaces of particles directly or via carrier fluid (liquid or gas)
4: Anisotropic particles whose morphology or surface composition has been modified

### DETAILED DESCRIPTION OF THE EMBODIMENTS

The invention is related to the fabrication techniques for anisotropic particles with different surface compositions and/or morphologies, which based on the application of controlled solidification, heat treatment, and surface forces on the isotropic particles.

Micro- and nano-sized particles can be produced with various methods and the particles that are produced with different methods can be used in this invention.

In some cases, a preparation period may be required for starting particles. Because, if the particle is to become liquid at some point during the process, there should be a shell layer around the particle which is protective to prevent it from coalescence with other particles, and is strong and flexible to withstand the volumetric changes occurring during the phase transition. This protective shell can be formed of a very thin oxide layer, an organic layer or a mixture thereof. A vast majority of metal materials form a protective oxide layer on their surface when exposed to an air. When a metal does not form its own oxide layer, or when the formed oxide layer does not have the desired mechanical properties, shell forming/improvement studies may be required. These studies may comprise the controlled reactivation of the surface with organic acids, or coating with polymer, surfactant (surface-active agent) or other materials with organic content or functionalization of the surface. This preparation stage has been previously used in different studies and the preparation procedures are described in detail. It is known that the bismuth-tin alloy used in the invention forms a protective tin-oxide layer on its surface.

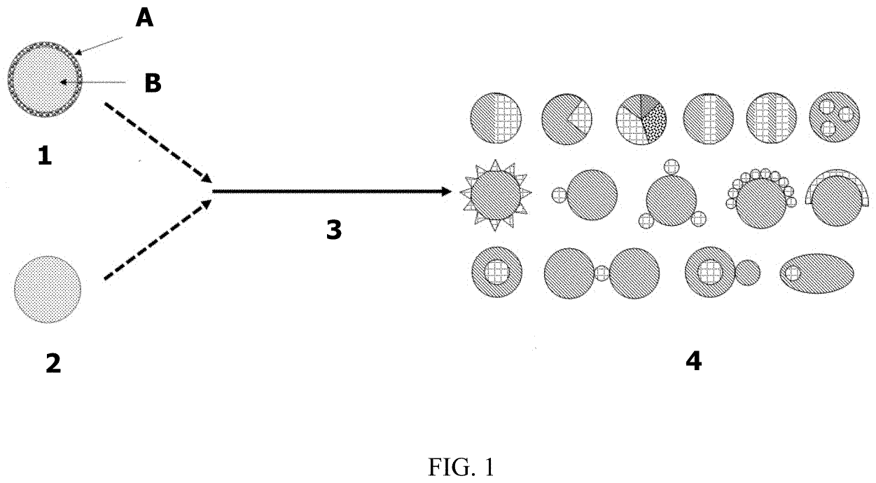

The fabrication procedure of anisotropic particles with various surface composition from isotropic (homogenous) particles is summarized in FIG. 1.

In the first step, alloy melt particles (1) at temperatures below equilibrium melting temperatures (supercooled) or at temperatures between melting temperature and boiling temperature are prepared. In this step, (i) particle with oxide shell can be obtained by melting of solid particles; (ii) a shell can be formed around solid particle by its functionalization with an organic agent, (iii) a supercooled particle trapped inside the shell can be used or (iv) a solid particle whose shell is functionalized with an organic acid can be used. (v) If the particle is to remain at a solid state during the process, there is no need for a shell formation. A solid alloy particle without a shell can be used. Various external forces (shear force, pressure, centrifugal force, magnetic or electric field, heat treatment or combinations thereof) are directly applied on the surfaces of particles via fluid (liquid or gas) (3); and particles having anisotropic surface composition and/or morphology is obtained (4). Different fillers represent different chemical content in the rightmost figure. The figures are illustrative only; although they present some alternatives, the possibilities are not limited to these illustrations. Using the same starting material, anisotropic particles with different structures may be obtained depending on the applied procedure. This procedure can be used to form much more complex hybrid structures by selective functionalization of particles in the next step. The particle samples presented in the invention are produced using the droplet emulsion technique. For this reason, an eutectic bismuth-tin alloy is used and the temperature is increased approximately 20° C. above its equilibrium melting point, and the alloy melted inside diethylene glycol at 160° C. is stirred at high speeds for the required period of time to form particles. Afterwards, the mixing liquid is cooled down and the particles are washed with ethanol or acetone using filtration or centrifuge techniques; then, are kept in ethanol for later use.

In this method, mixing speeds between 10,000 rpm and 45,000 rpm are applied for fabrication of micro- and nano-particles. The mixing speed affects the particle size. As the mixing speed increases, smaller sized particles can be produced (from a few nanometers up to 100 micrometers). Different mixing speeds can be applied according to the desired particle size. Mixing time affects the shell formation, the particle size and the particle size distribution. The particles in this example have been produced between 3 minutes to 30 minutes. This duration can be shorter or longer.

The micrographs presented in the invention are obtained using Backscattered Scanning Electron Microscopy (BSE-SEM). In this technique, elements with higher atomic number look brighter; therefore different colors represents the different compositions. In the micrographs presented here, the brighter and lighter areas represents the bismuth-rich compositions while dull and darker areas represents the tin-rich compositions.

The solid, melt, or supercooled isotropic particles at micro- and nano-size can be converted to the anisotropic particles by means of the below mentioned control methods.

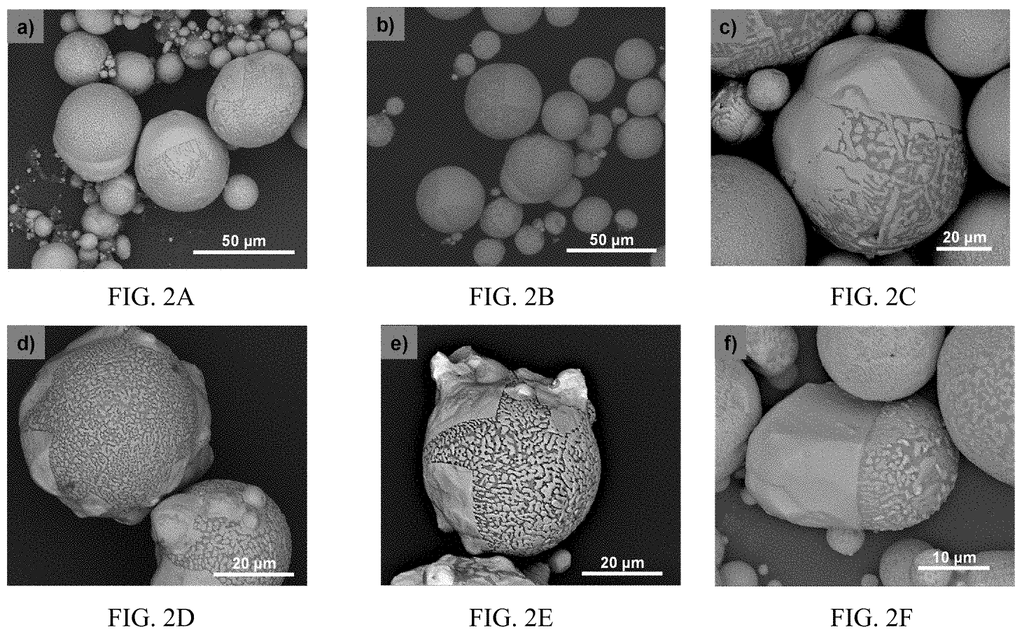

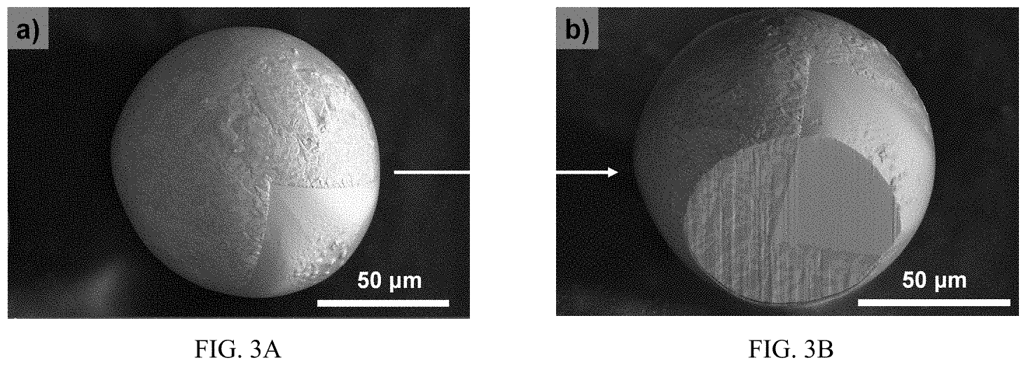

1. Equilibrium Phase Transitions: This covers the control of the surface chemistry during solidification depending on their compositions, though the eutectic, hypo-eutectic or hyper-eutectic phase transitions. The equilibrium phase particles are obtained by cooling of melts at the rates slow enough to reach the equilibrium structure. Different compositions may lead to different microstructures, thus the anisotropic particles with the different surface chemistry can be obtained (FIGS. 2A-2F). In order to illustrate this situation, bismuth-tin alloy particles are fabricated using an alloy at the eutectic composition in a diethylene glycol including glacial acetic acid at a ratio of 0.5-2.0 vol % and the above-mentioned procedure is followed. It is known that acetic acid is an abrasive chemical for tin and it does not react aggressively with bismuth. In other words, by means of selective reactive acetic acid use, the concentration of the eutectic alloy decreased to hypo-eutectic compositions, and the patchy and two-faced anisotropic structures illustrated in FIGS. 2A-2F could be obtained. One side of these structures are rich in bismuth while other parts have a eutectic microstructure (Bi-eutectic-BiSn Janus or patchy structure).

The anisotropic particle of the Bi-eutectic BiSn structure presented in FIGS. 3A and 3B, is sliced using a focused ion beam and the inner structures of the particles are examined. As a result, it is realized that the anisotropic structure observed on the surface is not only on the surface but it dominates all of the particles, in other words, it is observed that coreless anisotropic structures are obtained.

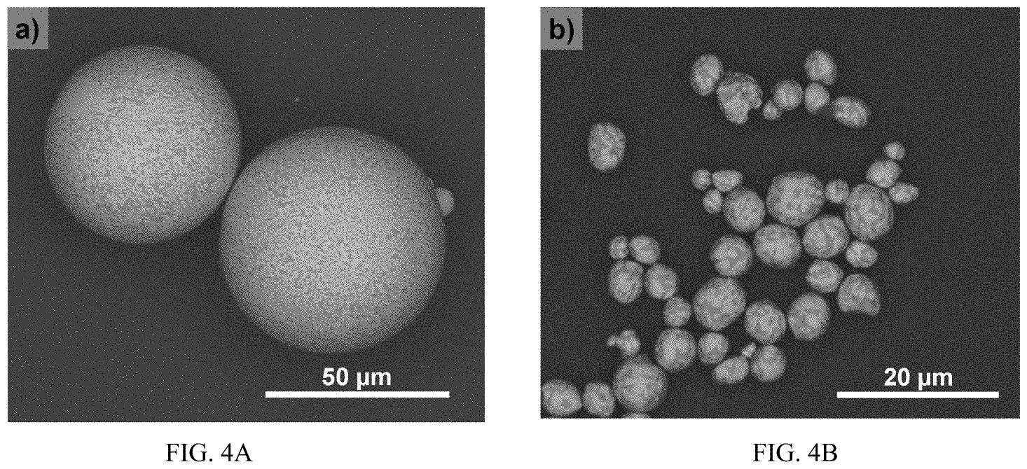

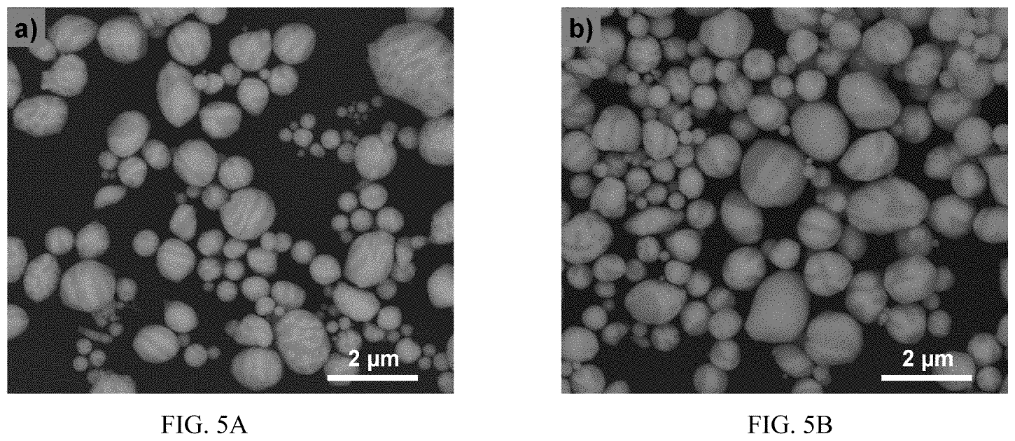

Equilibrium phase dispersions may differ according to particle size, and particles having different composition distribution can be obtained by change in particle size (FIGS. 4A and 4B). The surface microstructures of particles, particularly the ones with diameters less than 10 micrometers, may differ from the microstructures of larger particles or alloys. In FIGS. 4A and 4B, while the larger particles exhibit complex eutectic microstructure, the microstructure has become coarse as the particle sizes are reduced and a bismuth-tin composite structure is formed. The differences in particle microstructure due to particle sizes are clearly observed in several studies that shall be mentioned below.

2. Unequilibrium phase transitions: Anisotropic particles having different microstructures and therefore different surface chemistries can be obtained by rapidly cooling of the molten or the supercooled particles. The composition distribution of particles produced this way will be different than the particles obtained from equilibrium phase transitions.

In FIG. 5A, supercooled particles with a degree of supercooling of 150° C. (particles with solidification temperature of −11.5° C. while the equilibrium melting point is 138.5° C.) are solidified at −20° C. It is exemplified that the eutectic microstructure observed in equilibrium phase transition evolved into a striped microstructure with the effect of size and cooling/solidification rate. With a similar approach, various chemical distributions can be obtained by changing the particle size and/or solidification rate.

3. Phase separation induced by external forces: The surface compositions of the particles can be changed by application of external factors such as shear force, magnetic field, electrical field, centrifugal force, pressure, and heat onto the particles. These forces can be applied when the particles are solid, heated, or molten. The microstructure obtained in each case may vary. This leads to obtaining different microstructures thus different surface composition at particles. In general, these effects are directly or indirectly related to the density, surface tension, shear modulus and other mechanical, magnetic, thermal and electrical properties of the elements comprised of the alloys.

FIGS. 5A and 5B exemplify the effect of isothermal heat treatment on the composition distribution of particles. The particles having a striped microstructure presented in FIG. 5A, is kept for 8 hours in an oven at 120° C. As a result, as shown in FIGS. 5A and 5B, particles with coarser, less striped and/or patchy structures are obtained. The obtained microstructures can be varied by subjecting the particles with different microstructures to various heat treatment processes.

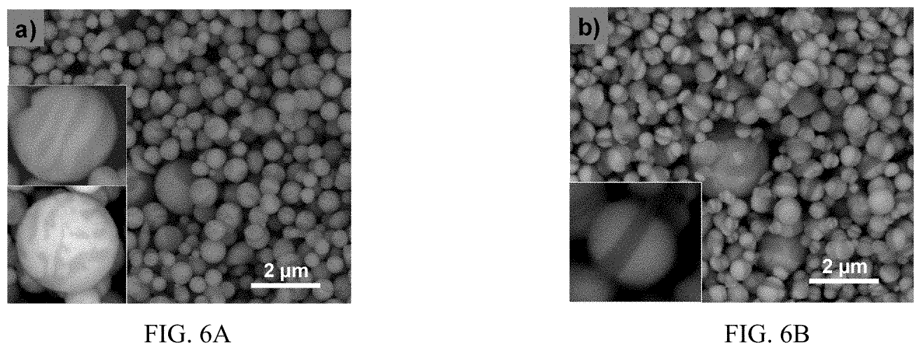

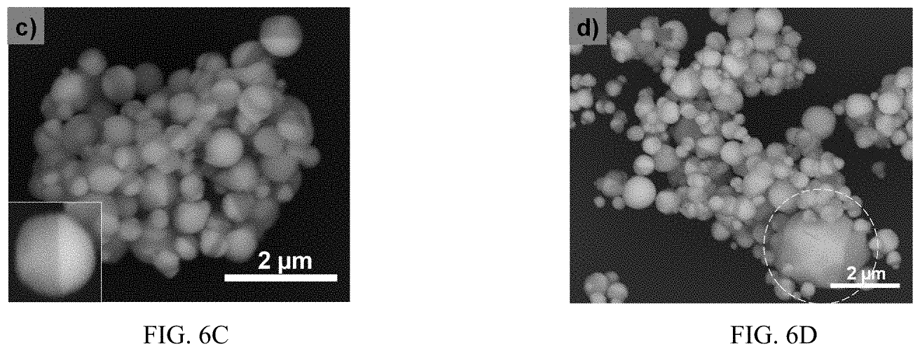

In FIGS. 6A, 6B, 6C and 6D, the effect of cyclic heat treatment on the microstructure is exemplified. The heat treatments in the invention are applied in the differential scanning calorimetry (DSC) cell. The supercooled particles have first been solidified by cooling down to −80° C.; and as shown in FIG. 6A, the particles mainly with patchy or striped structures are obtained.

These particles are heated up to 300° C. and melted, then cooled back down to −80° C. and solidified; and as shown in FIG. 6B structures with single stripe are formed. When a similar cyclic treatment is repeated once more, the single striped structure is evolved into a two-faced Janus structure (FIGS. 6C and 6D). One side of the Janus structures formed is bismuth-rich and the other side is tin-rich. The fabricated supercooled particles have small sizes. Therefore, the obtained Janus particles have a diameter of a few microns or less. However, as it can be seen at the bottom right part of FIG. 6D, that similar Janus structures can be obtained in particles having a diameter of 3-4 microns or larger.

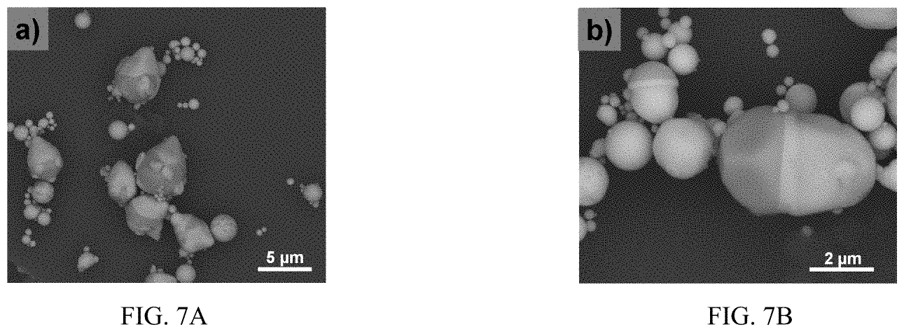

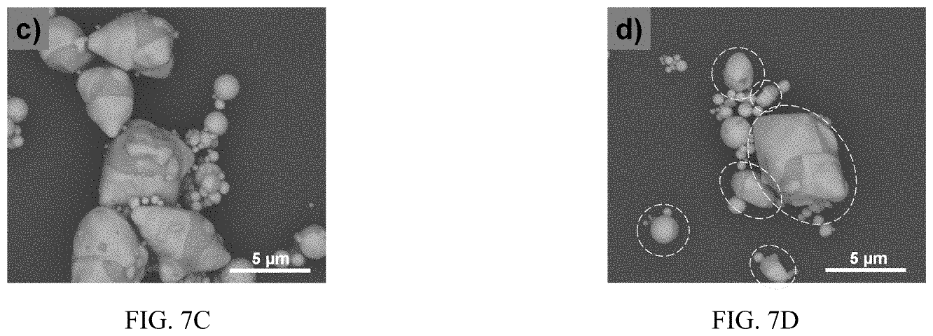

In FIGS. 7A, 7B, 7C and 7D, the effect of high speed mixing and cooling on the microstructure is exemplified. When the particles that are mixed at high speed (>10,000 rpm) and high temperatures (>140° C.) are left to be cooled to room temperature, the particles solidify into different microstructures depending on their particle sizes. In the examples shown in FIGS. 7A, 7B, 7C and 7D, particles with both morphological and chemical anisotropy are commonly obtained. The Bi-rich sides are protruded outwards due to increase in volume during solidification, which leads to morphological anisotropy. The shapes that are obtained vary depending on the particle size. The particles which are 4-5 microns or larger are formed tin particles decorated with bismuth. These particles can be evaluated under the category of patchy particles. The reproducibility of this complex particle morphology is noteworthy. In 1-4 micron sizes, two-faced Janus structures are formed, where one side is rich in bismuth and the other side is rich in tin. Smaller particles are more isotropic (spherical) and they can have supercooled structures or other microstructures as discussed in the previous examples.

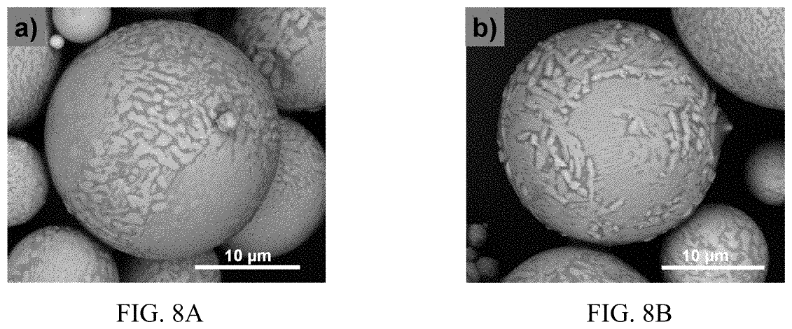

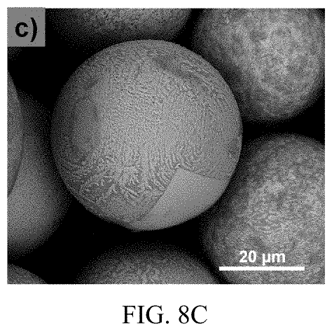

In FIGS. 8A, 8B and 8C, the effect of mixing, in other words the effect of shear force, on particle microstructure is exemplified. In this example, a wide anchor blade type mixer is used. Therefore, this mixer provides a more efficient mixing and changes the profile of shear force effecting the surface. This causes the particle surface to be completely or partially rich in bismuth. The reason for the surface to be rich in bismuth rather than tin is that the shear modulus of bismuth is lower than that of tin. While regional enrichments are present in FIG. 8A; in FIG. 8B the striped microstructure becomes coarse and the surface is rich in bismuth. In FIG. 8C, a structure similar to the enrichment in FIG. 8B can be observed at the eutectic part of the particle within the Janus structure. In this example, the difference between the coreless and core-shell structure can clearly be seen. In the example, it can be observed that one side of the particle is bismuth-rich, while the other side has a eutectic microstructure that is enriched by bismuth only on the surface; in other words, it can be inferred that this particle has a core-shell structure.

What is claimed is:

1. A method of producing nano-meter and micro-meter sized particles having an anisotropic composition distribution, comprising the steps of:
preparing alloy particles, wherein the alloy particles are covered with a shell under an equilibrium melting temperature or at a temperature between a melting temperature and a boiling temperature,
applying various external forces, wherein the various external forces are a shear force, a pressure, a centrifugal force, a magnetic or electric field, a heat treatment or combinations of the shear force, the pressure, the centrifugal force, the magnetic or electric field and the heat treatment, directly or by a fluid, wherein the fluid is a liquid or a gas, on surfaces of the alloy particles enveloped with or without the shell prepared under the equilibrium melting temperature or at the temperature between the melting temperature and the boiling temperature; and
obtaining anisotropic particles with modified surface compositions and/or morphologies.

2. The method according to claim 1, wherein the method is used in forming hybrid structures.

3. Alloy particles enveloped with a shell under an equilibrium melting temperature or at a temperature between a melting temperature and a boiling temperature or the alloy particles without shells, wherein the alloy particles are used in a production of nano-meter and micro-meter sized anisotropic particles.

4. The alloy particles according to claim 3, wherein the alloy particles are Bi—Sn alloys.
